(19) United States
(12) Patent Application Publication
(10) Pub. No.: US 2002/0107961 A1
(43) Pub. Date: Aug. 8, 2002

(54) Secure internet communication system

(76) Inventor: Naoya Kinoshita, Tokyo (JP)

Correspondence Address: Billy A. Robbins, Esq., FULBRIGHT & JAWORSKI L.L.P., 29th Floor, 865 South Figueroa Street, Los Angeles, CA, 90017-2576, US

(21) Appl. No.: 09/778,680

(22) Filed: Feb. 7, 2001

(51) Int. Cl. G06F 15/173; G06F 11/30; G06F 12/14; H04L 9/00

(52) U.S. Cl. 709/225; 713/201

(57) ABSTRACT

A secure Internet communication system for PC users housed in a multi-unit building, each unit including at least one PC, comprises one or more computer communication outlets in each unit for plugging in one or more PCs as part of a multi-unit building LAN. Each computer communication outlet is connected to a port on a VLAN-capable switching hub via a shared or dedicated cable connection. The switching hub is operatively coupled to a router which connects via a dedicated high-speed data communication link to an ISP router with the ISP having firewall capability. The switching hub is configured to support multiple VLANs with the one or more network PCs in each unit grouped as a separate VLAN. Each unit corresponds to a VLAN and a VLAN may include one or more network PCs. The VLAN configuration of the switching hub prohibits direct communication between different VLANs via the switching hub to ensure complete privacy and security for network users. Communication between different VLANs is possible only by posting e-mail on the Internet via the ISP. Each computer communication outlet has a pre-assigned unique port number and each connected PC is assigned a static IP address during network registration. The router uses an ARP table to store the static IP address and MAC address for each network PC and automatically verifies address information during each communication attempt. The router is configured for data packet filtering to restrict certain types of inbound data transmission from the Internet and to selectively block a range of IP addresses during data transmission from the Internet.

### BACKGROUND OF THE INVENTION

1. Field of the Invention

The present invention relates generally to telecommunications and more particularly to a secure Internet communication system for use by a plurality of computer users housed in a building.

2. Prior Art

Electronic communication networks are widely known and accessed nowadays. Among such networks are the Internet, on-line services, e-mail services and wide area networks. Access to such electronic communication networks can be provided by various well known means. One common means is via an Internet service provider (ISP) which provides access to the Internet for individual users. The Internet generally includes numerous computers that communicate with each other using common (well-established) communication protocols, commonly known as data packet transfer protocols, one example of which is the TCP/IP protocol. The ISP is typically connected to an Internet center such as the nearest super computer center forming part of the “backbone” of the Internet via a high-speed communications line.

Once a user calls in to the ISP, a dial-up connection to the Internet (via the ISP) is established. A user can then send and receive messages over the Internet. “Messages” as understood in this description may include any form of communication via a communications network, including, by way of example, any form of digital signals, URL requests, HTML transfers, JAVA code, e-mail messages, FTP transfers, voice, music, Telnet links, and the like.

The dial-up connection is probably the most popular means of connecting to communications networks. In a dial-up connection, the user's computer is equipped with a modem, which dials a telephone number to connect to the network. Once a “handshake” is completed between the user's modem and the ISP modem, a connection is accomplished and communications access is provided. Dial-up connection unfortunately suffers the disadvantage of relying upon conventional telephone lines to accomplish a data transmission connection and is, therefore, dependent on telephone network dial tone availability. Likewise, the speed of the connection is limited by the narrow bandwidth available via conventional telephone lines and by the speed of the user's modem with current modem standards being generally in the 14,400 through 56,000 bps range.

Another form of dial-up connection may be accomplished using an ISDN telephone line and an ISDN modem. Although a somewhat faster communications link may be achieved with an ISDN setup, many of the above-identified telephone line/modem disadvantages still apply. Although a relatively wider bandwidth is provided via an ISDN link, that bandwidth is still relatively narrow in comparison with the bandwidth available via a direct high speed dedicated linkage to a communications network.

T-1 links provide somewhat higher connection speed, however T-1 links suffer the disadvantages of being relatively costly in terms of installation and maintenance costs and are generally not widely accessible using portable communications equipment.

Nowadays, cable modems are available for high-speed linkage to the Internet by the individual user via conventional TV cables. However, cable modems suffer the disadvantages of requiring special access equipment and software and once connected the cable user must share available bandwidth with a great number of users in his/her immediate vicinity.

For users housed in a building or similar setting, the need for a secure high-speed Internet communication system is of utmost importance and may be met by forming a hub-based local area network (LAN) to connect all personal computers (PCs) in the various units of the building to a switching hub. Each PC would be equipped with a network interface card (NIC) such as a 10BaseT Ethernet NIC. A LAN of this type would be relatively easy to set up and maintain in building which has been pre-wired at the time of construction for a high-speed Internet connection. The building LAN may be segmented into a number of virtual LANs (VLANs) to enhance network security and provide a convenient high-speed link to the Internet which would be available at all times for use by a network member. Providing a building with a secure Internet communication system of this type would enhance the property value of the building and provide a reliable and low cost solution to the above-described problems of the prior art.

### SUMMARY OF THE INVENTION

The present invention is directed to an Internet communication system that meets the above needs and services a plurality of computers housed in a multi-unit building through an Internet Service Provider (ISP). The Internet communication system comprises a local area network (LAN) composed of the plurality of computers operatively coupled to a switching hub; a router operatively coupled between the switching hub and the ISP for connecting the LAN to the Internet; and means for providing network security for members of the multi-unit building LAN. Each of the plurality of computers on the multi-unit building LAN includes a LAN interface card with a unique media access control (MAC) address. The router is operatively coupled to a router of the ISP by way of a dedicated high-speed two-way data communication link, the dedicated high-speed two-way data communication link transmitting data packets, each of the data packets having an Internet Protocol (IP) header including a destination IP address, a source IP address and a block of binary data. The ISP is connected to the Internet by way of a high speed data communication link.

In accordance with one aspect of the present invention, the network security means includes a plurality of virtual LANs (VLANs) segmented from the multi-unit building LAN by way of the switching hub, each unit of the multi-unit building corresponding to a VLAN, each VLAN comprising at least one computer of the plurality of computers operatively connected to a port on the switching hub, the VLAN segmentation preventing direct communication between different VLANs by way of the switching hub.

In accordance with another aspect of the present invention, the network security means further includes a firewall on the ISP for preventing unauthorized access to the multi-unit building LAN from outside.

In accordance with yet another aspect of the present invention, the network security means further includes a MAC address look-up table on the switching hub for authenticating each computer on the multi-unit building LAN during data communication.

In accordance with still another aspect of the present invention, the network security means further includes an address resolution protocol (ARP) table on the router for storing static IP addresses assigned to the plurality of computers on the multi-unit building LAN and corresponding MAC addresses of the plurality of computers on the multi-unit building LAN and for authenticating the stored IP and MAC addresses during data communication to prevent unauthorized network use.

In accordance with a different aspect of the present invention, the network security means further includes a computer communication identification (ID) port number allocated to each of the network computers for user authentication purposes, the ID port number automatically recognized by the router during data communication.

In accordance with a still different aspect of the present invention, the network security means further includes a data packet filter on the router for restricting the type of inbound transmission data from the Internet and for selective blocking of a range of IP addresses during data transmission from the Internet.

These and other aspects of the present invention will become apparent from a review of the accompanying drawings and the following detailed description of the preferred embodiments of the present invention.

### BRIEF DESCRIPTION OF THE DRAWINGS

FIG. 1 is a functional block diagram of a secure Internet communication system in accordance with the present invention;

FIG. 2 is a functional block diagram of a router used as an Internet gateway for a PC whereby the router and the PC are part of the secure Internet communication system of FIG. 1 in accordance with the present invention;

FIG. 3 is a front perspective view of a switching hub connected to a plurality of PCs in accordance with the present invention;

FIG. 4 is a front perspective view of a switching hub configured to support a plurality of virtual local area networks (VLANs) with each VLAN connected to the switching hub and comprising at least one PC in accordance with the present invention;

FIG. 5 is a schematic representation of the setup shown in FIG. 4 with the VLAN-configured switching hub operatively coupled to a router in accordance with the present invention; and

FIG. 6 is a schematic representation of a preferred embodiment of the present invention.

### DETAILED DESCRIPTION OF THE PREFERRED EMBODIMENTS

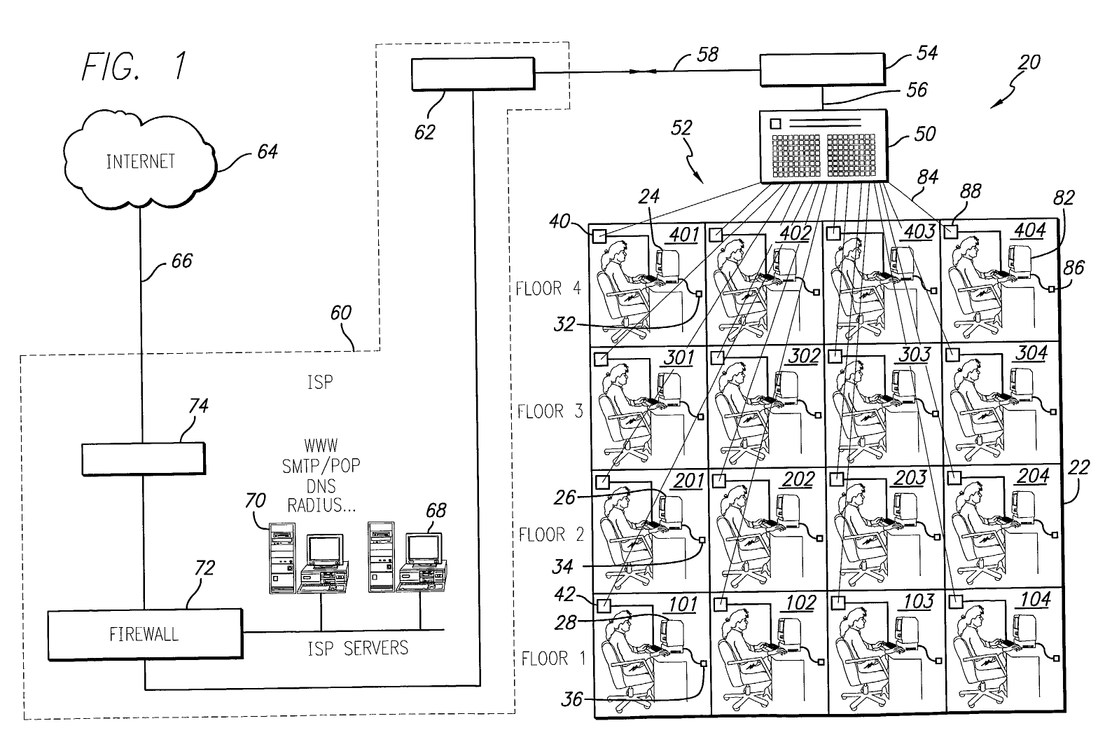

Hereinafter, some preferred embodiments of the present invention will be described in detail with reference to the related drawings of FIGS. 1-6. Additional embodiments, features and/or advantages of the invention will become apparent from the ensuing description or may be learned by the practice of the invention.

In the figures, the drawings are not to scale and reference numerals indicate the various features of the invention, like numerals referring to like features throughout both the drawings and the description.

The following description includes the best mode presently contemplated for carrying out the invention. This description is not to be taken in a limiting sense, but is made merely for the purpose of describing the general principles of the invention.

The present invention is directed generally to a secure Internet communication system for a plurality of users housed in a building setting such as an apartment building, office building, educational facility, military facility, government facility, factory or the like. The building is generally divided into a number of units with each unit including at least one PC for use by a user. The building is also pre-wired (preferably at the time of construction) to provide one or more computer communication outlets in each unit for plugging in one or more PCs, respectively, as part of a multi-unit building LAN. Each PC is equipped with an appropriate NIC such as a 10BaseT Ethernet NIC or the like for connecting to the network. Each communication outlet is connected to a port on a network device such as a switching hub via a shared or dedicated cable connection, i.e. a unit may have two or more computer communication outlets sharing a cable connection to a particular port on the switching hub. The switching hub is operatively coupled to a router to allow communication with the Internet via an ISP. The router is connected via a dedicated high-speed link to an ISP router. To provide enhanced security at low cost to the building LAN members, the switching hub is preferably configured to support multiple virtual LANs (VLANs) whereby the one or more network PCs in each unit is/are grouped as a separate VLAN. Thus, each unit corresponds to a VLAN and a VLAN may include one or more network PCs, depending on the number of PCs present and configured for use in the secure Internet communication system of the present invention in each unit. The VLAN configuration of the switching hub prohibits direct communication between different VLANs (i.e., security from the inside) via the switching hub to ensure complete privacy for each unit user. A PC user in one unit/VLAN may not gain access to the hard drive of another user PC residing in a different unit/VLAN in the building. Communication between individual users or VLANs is possible only by posting e-mail on the Internet via the ISP. To ensure security from the outside, the ISP provides a firewall which may be configured according to the specific security needs of the network users. Further security measures may be incorporated in the Internet communication system of the present invention as will be described hereinbelow in reference to FIGS. 1-6, inclusive.

FIG. 1 depicts an Internet communication system 20 for serving a multi-floor building 22 with each floor divided into a plurality of units such as unit 401 on the fourth floor of building 22, unit 301 on the third floor of building 22, etc. Even though building 22 is shown in FIG. 1 with four floors and four units per floor, a building with more or less floors and/or more or less units per floor may also be used to practice the invention as long as such use falls within the scope and spirit of the present invention.

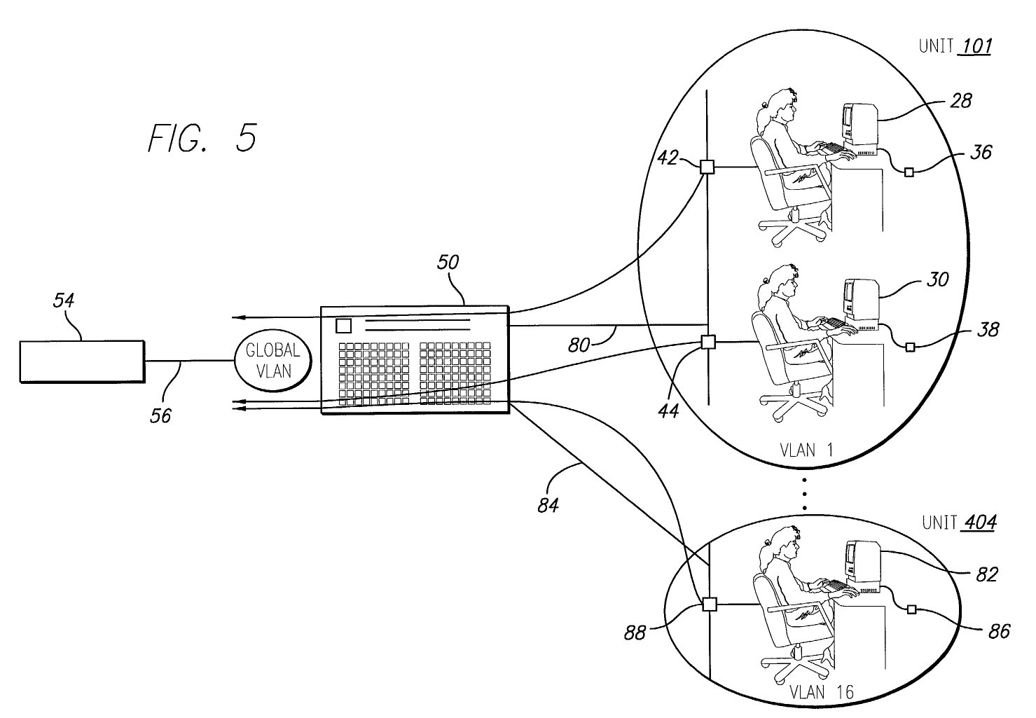

Each unit preferably includes at least one PC, e.g. PC 24 in unit 401, PC 26 in unit 201, PC 28 in unit 101, etc. (FIG. 1). FIG. 5 shows an alternative setup for unit 101 with two PCs 28, 30 instead of one PC. The number of PCs per unit that may be used to practice the invention depends on the needs of user(s) in each unit. Each PC is plugged into a power outlet such as power outlet 32 in unit 401, power outlet 34 in unit 201, power outlet 36 in unit 101 (FIG. 1) or power outlets 36, 38 in unit 101 (FIG. 5). Multi-unit building 22 is preferably wired at the time of construction to provide a computer communication outlet in each unit such as computer communication outlet 40 in unit 401, computer communication outlet 42 in unit 101 (FIG. 1) or alternatively, computer communication outlets 42, 44 in unit 101 (FIG. 5), etc. Each communication outlet is cabled to a port on a switching hub 50 (FIG. 1) via a shared or dedicated cable connection, i.e. a unit may have two or more computer communication outlets sharing a cable connection to a particular port on switching hub 50 (FIGS. 1, 5). Switching hub 50 may be located in building 22 or in close proximity thereof to establish data communication capability for each unit in building 22. Each PC includes an internal Ethernet NIC (not shown) such as a 10BaseT Ethernet NIC occupying an I/O (input/output) slot on its motherboard (not shown). An appropriate cable connection is provided between the Ethernet port on the NIC of each PC to a corresponding computer communication outlet to provide a network communication link for each network PC as shown in FIG. 1. Thus, a reliable “always on” hub-based LAN 52 is established to serve the needs of PC users residing in building 22.

Furthermore, each computer communication outlet is assigned a unique port number for identification (ID) purposes. The port ID number is allocated to a particular PC communication outlet at the time LAN 52 is set up by building network personnel.

Each Ethernet NIC is provided at the place of manufacture with a unique universally administered address, also known as MAC (media access control) address, which is permanently imprinted on the NIC. The MAC address is represented by six paired hexadecimal numbers, delimited by colons. For example, an Ethernet NIC may have the following unique MAC address: 99:02:11:D1:8F:19—the first two numbers (99) identify the NIC manufacturer. The IEEE (Institute of Electrical and Electronic Engineers), which is responsible for defining and publishing internationally accepted telecommunications and data communications standards, assigns a unique ID and a range of MAC addresses to each NIC manufacturer. In general, the NIC frames data that the computer's applications need to transmit, puts the framed data on the network in binary form and accepts inbound frames addressed to the computer. A frame is a structure used to transport a block of data across a network. The size and structure of the frame is determined by the hardware layer protocol used by the network, e.g., Ethernet, Token Ring, etc. For example, a standard Ethernet frame has a minimum of 64 octets and a maximum of 1500 octets in length, including payload and headers. The headers are used to identify the sender and recipient of each data packet and each address must be unique and six octets in length. Thus, the first 12 octets of each frame contain the six-octet destination address and the six-octet source address, also known as MAC addresses. Under normal operational conditions, Ethernet NICs will receive only frames whose destination addresses match their unique MAC addresses or satisfy their multicast criteria.

The preferred media access methodology for practicing the present invention is switched LAN media access provided by switching hub 50. A reliable, relatively low maintenance Layer 2 switching hub suitable for practicing the present invention may be purchased from Lucent Technologies of Murray Hill, N.J., e.g. a Cajun M400 switching hub or the like. As described hereinabove, each PC on LAN 52 is connected to a switched port on switching hub 50 and enjoys its own Layer 2 domain shared only with that switched port. A switching hub “learns” MAC addresses (of the connected PCs) and stores them in an internal MAC address look-up table for later use. The look-up table contains entries associating the MAC address of a network PC or node with the particular switched port on the switching hub. The node may be connected to the switching hub port via a shared or a dedicated cable connection (FIG. 5). Layer 2 of the International Standards Organization (ISO) Open Systems Interconnection (OSI) reference model is the data link layer which has two sets of responsibilities: transmitting and receiving. For example, on the transmit side, Layer 2 is charged with packing instructions, data, etc. into frames. Layer 2 also reassembles any binary streams received from the physical layer back into frames by buffering the incoming bits until a complete frame is received.

Switching hub 50 is preferably a VLAN-capable switching hub in accordance with the general principles of the present invention. A VLAN generally is a logical local area network composed of one or more physical LANs and configured according to a network administrator-defined criteria, e.g. LANs may be grouped based on geographical location, function, etc. A VLAN can be roughly equated to a broadcast domain and more specfically, VLANs may be seen as analogous to a group of end-stations (PCs) on single or multiple physical LAN segments that are not constrained by their physical location and that can communicate as if the end-stations were on a common LAN. VLANs offer significant benefits to network users in terms of efficient use of bandwidth, flexibility and performance. Obviously, using switches and routers that have embedded VLAN “intelligence” eliminates the need for expensive, time consuming recabling to extend connectivity in switched LAN environments.

Switching hub 50 is connected to a router 54 via a cable 56 (FIG. 1) which may be a twisted pair cable or any other suitable connector, provided such other connectors do not depart from the intended purpose of the present invention. A router operates at Layer 3 and includes two types of protocols: routing and routable. Routable protocols such as IP (Internet protocol) are used to transport data beyond the boundary of the Layer 2 domain. Routing protocols determine the optimal paths through the network for any given destination address and accept and forward data packets through these optimal paths to their destinations. Layer 3 of the International Standards Organization (ISO) Open Systems Interconnection (OSI) reference model is the network layer and as such is responsible for establishing the route to be used between the source and the host. This layer does not have native transmission error detection capability and relies on Layer 2 to provide a reliable data transmission service.

A router suitable for practicing the present invention may be purchased from Cisco Systems, Inc. of San Jose, Calif., e.g. a Cisco 2501 router or the like. The Cisco 2501 router is a LAN router, i.e. it has an integrated Ethernet LAN port with a MAC address and two serial ports for connection to a router of another LAN and has a minimum of 8 MB of Flash memory, DRAM memory capability and a 20 MHz 68030 type processor. There are two types of DRAM memory in a Cisco 2501 router: primary and shared. Primary memory is used generally to store the operating configuration, routing tables, caches and queues. Shared memory is used generally to store incoming and outgoing packets.

In accordance with a preferred embodiment of the present invention, router 54 communicates via a dedicated two-way high-speed data communication link 58 with a router 62 of an ISP 60 (FIG. 1). Dedicated link 58 may be fiber optic cable, ISDN, T-1 or the like. ISP 60 is linked to the Internet 64 via a router 74 and a high-speed data communication link 66 (FIG. 1) which may be fiber optic cable, satellite link, or the like. ISP 60 includes various servers such as ISP servers 68, 70 for use by the PCs on LAN 52. To prevent unauthorized use of LAN 52 from the outside, ISP 60 includes a firewall 72 which filters all incoming (from the outside world) LAN access requests according to a pre-set filtering configuration which is designed to satisfy the specific security needs of the members of LAN 52. For example, all access to LAN 52 from outside (e.g., non-client-initiated Internet communications) may be prohibited. As shown in FIG. 1, firewall 72 is operatively coupled between ISP servers 68, 70 and router 74.

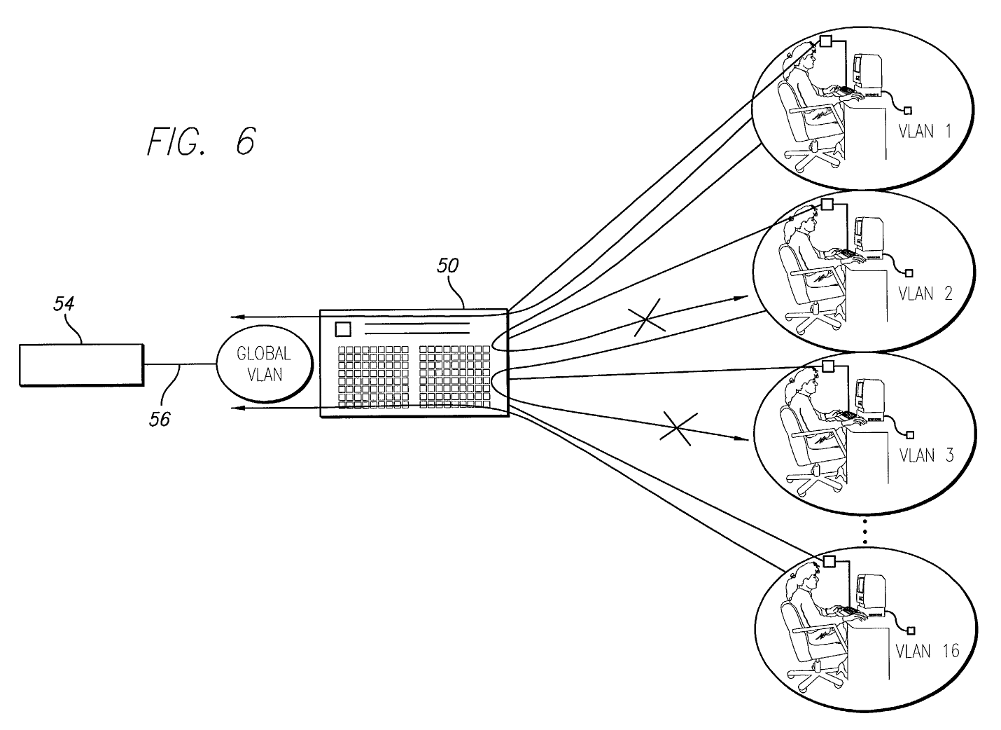

In accordance with another preferred embodiment of the present invention and to prevent unauthorized use of LAN 52 from the inside, VLAN-capable switching hub 50 is configured (by the building network personnel) to support multiple VLANs with one or more of the network PCs (or nodes) in each unit of building 22 grouped into a separate VLAN (FIGS. 3-6), i.e. LAN 52 is segmented into multiple VLANs. Each unit in building 22 corresponds to a VLAN and a VLAN may include one or more network PCs (FIGS. 5, 6) depending on the number of network PCs present in a unit. For example, unit 101 of building 22 is shown in FIG. 5 as a VLAN 1 having two nodes, namely PCs 28,30 which share a common cable connection 80 to a port (not shown) on switching hub 50. On the other hand, unit 404 of building 22 is shown in FIG. 5 as a VLAN 16 having a single node, namely, a PC 82 which has a dedicated cable connection 84 to a port (not shown) on switching hub 50. PC 82 is also shown plugged in a power outlet 86 and operatively connected to a computer communication outlet 88 which is coupled to dedicated cable connection 84.

In general, all messages (in the form of data frames) transferred between nodes of the same VLAN are transmitted at the MAC sublayer of the Data Link layer (i.e., Layer 2) based on the MAC layer address of each node. Due to the VLAN configuration of switching hub 50, there is no connectivity between nodes of different VLANs within switching hub 50. In other words, direct communication between individual VLANs via switching hub 50 is prohibited to ensure complete privacy and security for each network user. Therefore, a legitimate PC user in one unit/VLAN may not gain access to the hard drive of a PC belonging to another legitimate PC user residing in a different unit/VLAN in building 22. In this regard, FIG. 6 illustrates two examples of unsuccessful attempts to establish direct communication between different VLANs, i.e., VLAN 1 fails to communicate directly with VLAN 2 via switching hub 50 and VLAN 2 fails to communicate directly with VLAN 3 via switching hub 50. A person skilled in the art would appreciate the fact that if the VLAN configuration in switching hub 50 is not turned on, a PC in one unit/VLAN can establish direct communication with a PC in another unit/VLAN via switching hub 50 (FIG. 3) which would be an undesirable feature in terms of network security. To enable Internet communication for each VLAN, the global VLAN function of switching hub 50 is employed as illustrated in FIGS. 5-6.

In accordance with yet another preferred embodiment of the present invention, the routing function of router 54 is not used, i.e. communication between individual users (belonging to different VLANs) may be established only by posting e-mail on the Internet 64 via ISP 60. Thus, since the routing function of router 54 is not used and since switching hub 50 operates only at Layer 2 in accordance with the present invention, a simple but secure high-speed Internet communication system has been set up to meet the communication needs of the network users of building 22. A person skilled in the art would readily appreciate that secure Internet communication system 20 can be set at relatively low cost at the time of construction of building 22 and can operate reliably with low maintenance and operational costs at low communication load while at the same time fully meeting the security needs of its network users. A person skilled in the art would also appreciate that the inventive setup is a major improvement over the conventional use of xDSL modems and Layer 3 switches as part of complicated and expensive (to set up, maintain and operate) secure network configurations.

In accordance with still another preferred embodiment of the present invention, secure Internet communication system 20 uses an additional three-step security approach to provide secure connection to/from the Internet for each legitimate user of building 22. The first security step uses the manufacturer-provided unique MAC address on the NIC of each network PC. The second security step includes assigning a static IP address to each network PC which each user must input in his/her PC. The third security step uses the allocated port ID number discussed hereinabove to identify each legitimate network user.

To activate service for each PC, each user must first register his/her PC with the network administration center (not shown) via telephone or other suitable means. During the registration process, each user is assigned the static IP address (mentioned hereinabove) which is entered by network personnel into a router database on router 54. Each user then powers up his/her PC and enters the assigned static IP address in his/her PC. The assigned static IP address is available at all times to the user regardless of whether the PC of the unit is actually plugged in the corresponding computer communication outlet or not. With the static IP address entered, the PC is plugged in a respective computer communication outlet, e.g., PC 82 of unit 404 plugged in a computer communication outlet 88, for the first time and router 54 automatically queries the PC regarding its MAC address and stores the same in memory (primary memory—Cisco 2501 router) in the form of an ARP (Address Resolution Protocol) table for future use. The transmitted MAC address from the PC is also cached in the MAC look-up table of switching hub 50, i.e. switching hub 50 “learns” the MAC address of each connected PC. The ARP table contains a static IP address entry and a corresponding MAC address entry for each network PC. The allocated port ID number for each computer communication outlet is automatically recognized by router 54. Thus, all necessary identification information for each PC on the network is stored within router 54. From this point on, the data in the ARP table cannot be changed arbitrarily, i.e. only ARP data statically entered is cached in the ARP table of router 54 (ARP table update time set to “0”). An example of an internal ARP table for router 54 is presented herewith as follows:

IP Address MAC Address

172.16.49.135 00-40-8c-31-f1-35

172.16.49.140 08-00-1f-06-6a-1e

172.16.49.142 00-00-e2-1a-f7-1c

172.16.49.146 00-00-e8-37-09-48

172.16.49.147 00-00-e8-26-20-c4

172.16.49.200 00-60-97-7b-1d-58

172.16.49.202 00-00-e8-37-0c-ec

172.16.49.254 00-00-b0-02-5f-01

After the ARP table is complete, i.e. each network PC has been registered with router 54, a legitimate user in building 22 can connect to the network at any time by simply plugging in his/her PC into a corresponding computer communication outlet eliminating the need for dial-up access and associated connection delays, time-outs, reduced transmission speed and the like. To establish network connection, a certain connection routine is followed.

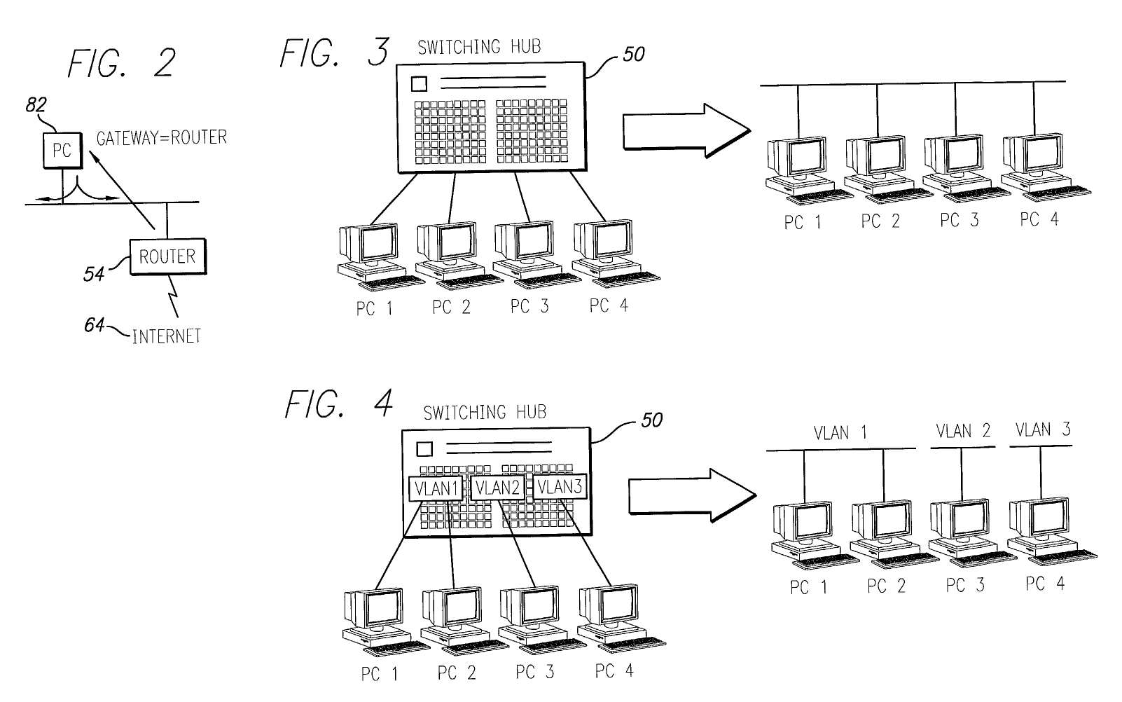

Since the PC (e.g., PC 82 in unit 404) knows the IP address of router 54 which is registered as a gateway (FIG. 2) for connection to the Internet 64, but does not know the MAC address of router 18, the PC broadcasts an ARP request packet to router 54 (FIG. 2) which contains its own static IP address and MAC address. Router 54 checks the received (via switching hub 50) PC MAC address and IP address against all MAC address and IP address entries in its ARP table (see example above) and if a match occurs, returns an ARP response packet to the PC providing its MAC address to the PC which caches the same in its own ARP table. Thus, no user can connect to the Internet 64 via router 54 unless the user's PC is first authenticated by router 54 in the manner described above. Data packets are transmitted by router 54 on a first-come-first-serve basis with each network PC being continuously queried by router 54 to ascertain whether data packets need to be transmitted.

In the event that the IP address of another user is used by mistake, router 54 will refuse access to the Internet 64 since the transmitted IP address will not match the static IP address entry stored in the router ARP table for that particular PC. It will be appreciated by a person skilled in the art that this type of error in no way interferes with the use of the network by other legitimate network users. Furthermore, if a user attempts to connect to the network using a legitimate IP address with an unregistered computer, e.g. a laptop computer, which will have a non-registered MAC address (on the laptop NIC), access to the network will again be declined—this time at the switching hub level since the transmitted laptop MAC address will not match any of the MAC address entries already stored in the MAC address look-up table of switching hub 50. The above-described setup may be used to connect two or more personal computers from each unit to the network provided that the connections of other legitimate users are not compromised by any setup errors. In other words, the user in a specific unit will have to register each new computer separately and be properly authenticated for use by switching hub 50 and router 54 in the manner described hereinabove.

In accordance with a different preferred embodiment of the present invention and to further enhance the security of Internet communication system 20, router 54 includes a data packet filtering capability to prevent improper access to LAN 52 from the outside world. Data packet filtering allows control at the port number level (restricting the type of data transferred) and at the IP address (network) level which is accomplished by configuring (software commands) the access control list (ACL) stored in memory (primary memory—Cisco 2501 router) of router 54. A port number is a way to identify a specific process to which an Internet or other network message is to be forwarded when it arrives at a server. Specifically, for TCP (Transmission Control Protocol) and UDP (User Datagram Protocol), a port number is a 16-bit integer that is put in the IP header which is appended to a message unit. This port number is passed logically between client and server transport layers and physically between the transport layer and the Internet Protocol layer and forwarded. For instance, a network user may request from a server on the Internet that a file be served from the host's FTP (File Transfer Protocol) server. In order to pass the user's request to the FTP server, the TCP software layer in the user's PC identifies the port number 21 (which by convention is associated with a FTP request) in the 16-bit port number integer that is appended to the request. At the server level, the TCP layer will read the port number 21 and forward the user's request to the FTP program residing in the server. Thus, the ACL of router 54 may be programmed at the port number level, for example, to refuse access to LAN 52 from the outside by TELNET (which has port number 23), to permit all access from the outside by FTP—port numbers 10/21, to permit access by SMTP (Simple Mail Transfer Protocol)—port number 25, to permit access by HTTP (Hypertext Transfer Protocol)—port number 80, etc. The data packet filter in router 54 may not permit a session activated from outside of LAN 52 with the provision that minimal access necessary to operate router 54 and switching hub 50 will be permitted and at the same time may permit full access to the Internet 64 from inside LAN 52. Furthermore, the ACL of router 54 maybe programmed at the IP address level to refuse access to a certain range of IP addresses. A data packet filtering example showing a programmed ACL for router 54 is presented herewith as follows:

interface Serial0

ip address 202.220.96.26/255.255.255.252

ip access-group 100 in

encapsulation ppp

Filter

1 access-list 100 permit ip any host 202.220.97.97

2 access-list 100 permit ip any host 202.220.97.98

3 access-list 100 permit icmp any any

4 access-list 100 permit tcp any any eq ident

5 access-list 100 deny udp any any eq 7648

6 access-list 100 permit udp any any

7 access-list 100 permit tcp any eq ftp-date any

8 access-list 100 permit tcp any any established

The above example shows filter instruction 3 permitting all transmissions (PING, etc.) of ICMP (Internet Control Message Protocol), filter instruction 4 permitting all transmissions (Mail) that use port 113 (corresponding to) TCP, filter instruction 5 denying all transmissions that use port 7648 of UDP, filter instruction 8 permitting transmissions that use TCP from building 22, etc. Specifically, during transmission of data packets, the data packet filter in router 54 automatically checks all (1-8) filter instructions in order starting from filter instruction 1 and when a match occurs, the transmission is either granted or denied by router 54.

The above-described secure Internet communication system 20 comprising building LAN 52, VLAN-configurable switching hub 50, data communication link 56, router 54, dedicated two-way data communication link 58, ISP 60, high speed communication link 66 and Internet 64 is relatively easy to set up, operate and maintain and provides reliable and unmatched (in the prior art) security and privacy for all legitimate network users.

It should be appreciated by a person skilled in the art that other components and/or configurations may be utilized in the above-described embodiments, provided that such components and/or configurations do not depart from the intended purpose and scope of the present invention.

While the present invention has been described in detail with regards to the preferred embodiments, it should be appreciated that various modifications and variations may be made in the present invention without departing from the scope or spirit of the invention. In this regard it is important to note that practicing the invention is not limited to the applications described hereinabove. Many other applications and/or alterations may be utilized provided that they do not depart from the intended purpose of the present invention.

It should be appreciated by a person skilled in the art that features illustrated or described as part of one embodiment can be used in another embodiment to provide yet another embodiment such that the features are not limited to the specific embodiments described above. Thus, it is intended that the present invention cover such modifications, embodiments and variations as long as they come within the scope of the appended claims and their equivalents.

What is claimed is:

1. An Internet communication system for servicing a plurality of computers housed in a multi-unit building through an Internet Service Provider (ISP), said Internet communication system comprising:
(a) a local area network (LAN) composed of said plurality of computers operatively coupled to a switching hub;
(b) a router operatively coupled between said switching hub and said ISP for connecting said LAN to the Internet; and
(c) means for providing network security for members of said multi-unit building LAN.

2. The Internet communication system of claim 1, wherein each of said plurality of computers on said multi-unit building LAN includes a LAN interface card with a unique media access control (MAC) address.

3. The Internet communication system of claim 2, wherein said router is operatively coupled to a router of said ISP by way of a dedicated high-speed two-way data communication link, said dedicated high-speed two-way data communication link transmitting data packets, each of said data packets having an Internet Protocol (IP) header including a destination IP address, a source IP address and a block of binary data.

4. The Internet communication system of claim 1, wherein said ISP is connected to the Internet by way of a high speed data communication link.

5. The Internet communication system of claim 1, wherein said network security means includes a plurality of virtual LANs (VLANs) segmented from said multi-unit building LAN by way of said switching hub, each unit of said multi-unit building corresponding to a VLAN, each VLAN comprising at least one computer of said plurality of computers operatively connected to a port on said switching hub, said VLAN segmentation preventing direct communication between different VLANs by way of said switching hub.

6. The Internet communication system of claim 1, wherein said network security means further includes a firewall on said ISP for preventing unauthorized access to said multi-unit building LAN from outside.

7. The Internet communication system of claim 2, wherein said network security means further includes a MAC address look-up table on said switching hub for authenticating each computer on said multi-unit building LAN during data communication.

8. The Internet communication system of claim 3, wherein said network security means further includes an address resolution protocol (ARP) table on said router for storing static IP addresses assigned to said plurality of computers on said multi-unit building LAN and corresponding MAC addresses of said plurality of computers on said multi-unit building LAN and for authenticating said stored IP and MAC addresses during data communication to prevent unauthorized network use.

9. The Internet communication system of claim 8, wherein said network security means further includes a computer communication identification (ID) port number allocated to each of said network computers for user authentication purposes, said ID port number automatically recognized by said router during data communication.

10. The Internet communication system of claim 3, wherein said network security means further includes a data packet filter on said router for restricting the type of inbound transmission data from the Internet and for selective blocking of a range of IP addresses during data transmission from the Internet.
